(19) United States
(12) Patent Application Publication
(10) Pub. No.: US 2021/0154970 A1
(43) Pub. Date: May 27, 2021

(54) DISCONTINUOUS THERMOFORMABLE COMPOSITE PRODUCTS

(71) Applicant: Shawmut LLC, West Bridgewater, MA (US)

(72) Inventors: James H. Wyner, Chestnut Hill, MA (US); Gregory F. Carey, Plymouth, MA (US); Mark J. Holbrow, Framingham, MA (US); Richard J. Pierce, JR., Plymouth, MA (US)

(21) Appl. No.: 17/104,171

(22) Filed: Nov. 25, 2020

Related U.S. Application Data
(60) Provisional application No. 62/939,989, filed on Nov. 25, 2019.

(51) Int. Cl. B32B 5/24; B32B 5/18; B32B 5/02; B32B 5/32; B32B 37/06; B29C 51/14; B60R 13/02

(52) U.S. Cl. CPC B32B 5/245; B32B 5/18; B32B 5/022; B32B 5/026; B32B 5/32; B32B 2037/0092; B29C 51/14; B60R 13/0212; B32B 2266/0278; B32B 2266/025; B32B 2605/003; B32B 37/06

(57) ABSTRACT

Compositions, systems, devices, and methods for making a headliner, e.g., a substrate having a laminated textile laminate or coverstock attached to a surface thereof, are discussed herein. The substrate can include a fabric-foam laminate that is directly attached to the substrate without the use of an adhesive layer. The foam can be flame bonded to the substrate and the textile simultaneously by activating the adhesive properties of the foam. In some embodiments, the headliner does not include a non-woven fabric layer in the manufacturing of the headliner.

### CROSS-REFERENCE TO RELATED APPLICATION(S)

This patent application claims the benefit of U.S. Provisional Patent Application No. 62/939,989 entitled COMPOSITIONS, SYSTEMS, DEVICES, AND METHODS FOR MAKING AN ALL-IN-ONE HEADLINER USING FLAME LAMINATION filed Nov. 25, 2019, which is hereby incorporated herein by reference in its entirety.

### FIELD OF THE APPLICATION

The present application relates broadly to the composition and systems, devices, and methods for making a headliner using flame lamination. More specifically, portions of the application are related to a novel, all-in-one, thermoformable composite that includes a fabric-to-foam-to-substrate laminate for use in a variety of applications including production of vehicle interior surfaces such as automobile headliners.

### BACKGROUND

Headliners are composite materials that are adhered to the inside of vehicles such as cars, buses, planes, and/or yachts. Headliners typically consist of an outward-facing decorative textile material, such as a tricot knit fabric, having a foam, or foam-laminated-to-nonwoven backing that can provide a soft touch and uniform appearance. The headliners are typically produced by using heat pressure and/or vacuum to form a semi-rigid composite sheet into a concave shell, while simultaneously or subsequently bonding the decorative textile onto the interior surface of a semi-rigid formed/contoured base, such as in the methods discussed below.

For example, in what is commonly referred to as a “wet process,” a thermoformable semi-rigid MDI-based urethane foam is combined with glass fiber, nonwoven “scrim,” and coated with a catalyzed reactive liquid urethane adhesive. The structure is then fed into a heated tool, along with a decorative surface material, or coverstock, which is typically a knitted fabric laminated to polyurethane foam, a non-woven barrier layer, or other backing. When foam is the backing material, a third ply such as a non-woven scrim or a film may be adhered to the back of the foam as a processing aid. Alternatively, the coverstock may also be a monolithic, decorative non-woven fabric, either laminated or unlaminated, but knitted fabric laminates are typically the most common. The structure is then fed into a heated tool to activate the adhesive, which bonds the materials together into a rigid contoured structure that can then be assembled into a finished headliner. Alternatively, a pre-form process that includes the two steps of: (1) creating a molded base using a reactive liquid urethane foam; and (2) adhering a decorative layer to the molded base. Still further, a “dry process” can be used to manufacture the headliner by heating a thermoformable semi-rigid substrate, such as one comprised of glass impregnated polypropylene, topped with a heat-activatable adhesive film, to the softening point. The coverstock can then be laid onto the substrate and fed into a forming press such that the two layers are simultaneously molded and laminated together using the thermoplastic adhesive film.

These existing methods for manufacturing automotive headliners have several shortcomings. Use of an adhesive film to attach the coverstock to the substrate extends the time of production and increases risk of damage of the coverstock by bleeding through the fabric. Additionally, the non-woven scrim that is often included in manufacturing of the automotive headliners to facilitate lamination, as described above, has a high cost despite simply being used as a processing aid in the manufacturing process and not performing a function in the finished product. Further, the in-tool lamination process for both processes, is slow and difficult to control, while also being subject to variation such as surface irregularities (“mottling”) and lamination strength failures. In addition, the preparation, heating, and feeding of multiple layers into the molding press in a controlled fashion requires large, automated handling systems. These systems can result in expenditure of high levels of capital investment that consumes large amounts of space, which further raises fixed costs and the minimum efficient scale (breakeven volume) of the typical headliner molding plant.

Accordingly, a lower cost, improved performance molded automotive headliner, and methods for making such a headliner, is needed.

### SUMMARY OF VARIOUS EMBODIMENTS

In accordance with one embodiment of the invention, a discontinuous thermoformable composite product comprises a polyurethane foam, a rigid substrate, and a cover, wherein the cover is bonded to the polyurethane foam, and wherein the polyurethane foam is directly bonded to the substrate by a first amorphous and porous urethane product of the polyurethane foam without an intervening layer of adhesive.

In various alternative embodiments, the first amorphous and porous urethane product may be a pyrolytic decomposition product of the polyurethane foam. The foam may be any one of a polyester, polyether, or other polymer-based polyurethane foam. The foam may have a density in a range from about 1.4 pounds per cubic foot to about 4.0 pounds per cubic foot, for example, a density in a range from about 1.7 pounds per cubic foot to about 2.2 pounds per cubic foot. The foam may include one or more reactive polyols that decompose when heated. The cover may be directly bonded to the polyurethane foam by a second amorphous and porous urethane product of the polyurethane foam without an intervening layer of adhesive. The cover and the polyurethane foam may be provided as a cover-to-foam laminated coverstock, in which case the polyurethane foam of the coverstock may be directly bonded to the substrate by the first amorphous and porous urethane product of the polyurethane foam without an intervening layer of adhesive, and the cover may be directly bonded to the polyurethane foam by a second amorphous and porous urethane product of the polyurethane foam without an intervening layer of adhesive.

In further alternative embodiments, the substrate may comprise a plurality of materials that are pre-formed into a single piece or may be a discontinuous glass-filled expanded polypropylene substrate. In any case, the materials of the substrate may be thermoformable.

In still further alternative embodiments, the cover may be a textile. The textile may include a knitted fabric, which may weigh less than about 2.2 ounces per square yard and/or may be a lightweight flat knit fabric. The textile may exclude a non-woven fabric layer such as a non-woven fabric layer that is often used for forming a laminate using an intervening layer of adhesive.

In any of the above-mentioned embodiments, the discontinuous thermoformable composite product may be a pre-laminated thermoformable board (e.g., for subsequent use in a molding machine) or may be a component for a vehicle interior such as a vehicle headliner.

In accordance with another embodiment, a method for manufacturing a discontinuous thermoformable composite product comprises providing a rigid substrate, providing a polyurethane foam, providing a cover, and forming a discontinuous thermoformable composite product in which the cover is bonded to the polyurethane foam and the polyurethane foam is directly bonded to the substrate by a first amorphous and porous urethane product of the polyurethane foam without an intervening layer of adhesive, said forming comprising applying energy to the polyurethane foam to create the first amorphous and porous urethane product.

In various alternative embodiments, applying energy to the polyurethane foam may involve flame bonding and in any case may involve heating the polyurethane foam to a temperature of at least 350 degrees Celsius to decompose reactive polyols contained therein. The first amorphous and porous urethane product may be a pyrolytic decomposition product of the polyurethane foam. The direct bonding of the polyurethane foam to the substrate generally does not occur thermoplastically. The foam may be any one of a polyester, polyether, or other polymer-based polyurethane foam. The foam may have a density in a range from about 1.4 pounds per cubic foot to about 4.0 pounds per cubic foot, for example, a density in a range from about 1.7 pounds per cubic foot to about 2.2 pounds per cubic foot. The foam may include one or more reactive polyols that decompose when heated.

In still further alternative embodiments, providing the polyurethane foam and the cover may involve providing a cover-to-foam laminated coverstock. Providing the cover-to-foam laminated coverstock may involve forming the cover-to-foam laminated coverstock by applying energy to the polyurethane foam to create a second amorphous and porous urethane product of the polyurethane foam that directly bonds the polyurethane foam to the cover without an intervening layer of adhesive.

In still further alternative embodiments, the rigid substrate, the polyurethane foam, and the cover may be provided separately, in which case applying energy to the foam may create the first amorphous and porous urethane product and may create a second amorphous and porous urethane product of the polyurethane foam to directly and simultaneously bond the polyurethane foam to both the cover and the substrate without intervening layers of adhesive.

In further alternative embodiments, the substrate may comprise a plurality of materials that are pre-formed into a single piece or may be a discontinuous glass-filled expanded polypropylene substrate. In any case, the materials of the substrate may be thermoformable.

In still further alternative embodiments, the cover may be a textile. The textile may include a knitted fabric, which may weigh less than about 2.2 ounces per square yard and/or may be a lightweight flat knit fabric. The textile may exclude a non-woven fabric layer such as a non-woven fabric layer that is often used for forming a laminate using an intervening layer of adhesive.

In any of the above-mentioned embodiments, the discontinuous thermoformable composite product may be a pre-laminated thermoformable board (e.g., for subsequent use in a molding machine) or may be a component for a vehicle interior such as a vehicle headliner.

In any of the above-mentioned embodiments, the method may be continuous.

In accordance with yet another embodiment, a method for manufacturing a molded composite product comprises providing a pre-laminated thermoformable board having polyurethane foam bonded to a cover and directly bonded to a substrate by a first amorphous and porous urethane product of the polyurethane foam without an intervening layer of adhesive, placing the pre-laminated thermoformable board in a thermoforming molding machine, and operating the thermoforming molding machine to form the molded composite product.

In various alternative embodiments, the molded composite product may be a component for a vehicle interior such as a vehicle headliner.

Additional embodiments may be disclosed and claimed.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a schematic diagram showing formation of a discontinuous thermoformable or thermoformed composite product in accordance with a first exemplary embodiment.

FIG. 2 is a schematic diagram showing formation of a discontinuous thermoformable or thermoformed composite product in accordance with a second exemplary embodiment.

It should be noted that the foregoing figures and the elements depicted therein are not necessarily drawn to consistent scale or to any scale. Unless the context otherwise suggests, like elements are indicated by like numerals. The drawings are primarily for illustrative purposes and are not intended to limit the scope of the inventive subject matter described herein.

### DETAILED DESCRIPTION

Systems, devices, and methods for making a headliner, e.g., a substrate or board having a coverstock, e.g., a textile to foam laminate, attached to a surface thereof, are discussed herein. A person skilled in the art will recognize that, for some embodiments, the systems, devices, and methods provided for herein can generally relate to improvements to the composition of headliners manufactured using the dry process discussed above. In some embodiments, the substrate can be thermoformable such that heating the substrate can allow the structure of the substrate to be molded into a desired shape. The coverstock can be attached as a topcoat to one or more surfaces thereof. In some embodiments, the coverstock can be integratedly formed on the substrate such that the substrate and the coverstock are an all-in-one formable component. The coverstock can be attached to the substrate using flame lamination to form the all-in-one formable component. The flame lamination can use decomposed foam as a bonding agent to attach the coverstock to the substrate. In some embodiments, the flame lamination of the fabric to the foam to form the coverstock can occur virtually simultaneously with attaching the coverstock to the substrate (it can be done in rapid succession such that both lamination stations are installed in line on a single machine and are in simultaneous operation but the lamination of each side of any given location on the web are staggered in time).

Certain exemplary embodiments will now be described to provide an overall understanding of the principles of the structure, function, manufacture, and use of the devices and methods disclosed herein. Those skilled in the art will understand that the systems, devices and methods specifically described herein and illustrated in the accompanying drawings are non-limiting exemplary embodiments. The features illustrated or described in connection with one exemplary embodiment may be combined with the features of other embodiments.

The exemplary embodiments discussed herein are directed to textile composites that are attached to a board, or substrate, to manufacture automotive headliners. Headliners can be used to line a portion of a vehicle, e.g., surfaces forming part(s) of a passenger cabin, storage space, or other interior and/or exterior portions of one or more of an automobile, truck, airplane bus, etc. Headliners can include multi-layered materials that can be customized for specific look, feel, stiffness, and/or sound reduction. In the automotive space, headliners manufactured using the materials and methods disclosed herein can also be used to produce interior components such as sunshades, sun visors, package trays, pillars, door panels, and/or trunk liners. In some embodiments, the resulting headliners can be used to support ventilation ducting, air conditioning, lighting systems, and anchoring devices for aesthetic or safety enhancements, as well as to conceal wiring, airbags, and/or other functional systems within the vehicle.

The substrate can be a single piece of material and/or a plurality of materials that are pre-formed into a single piece. The substrate can be made from a wide range of materials that can be molded such that the board can form and deform into various shapes. Some non-limiting examples of materials that can make up the substrate can include glass-filled, expanded polypropylene sheet materials, such as those produced by Hanwha Azdel (available from Azdel Composite and Material Solution, Forest, Va.), or Stratas 3D conventional headliner composite and Stratas HS High-strength headliner composites (available from Woodbridge Foam Corporation), or glass-encased polyurethane bases, e.g., composite sheets of semi-rigid polyurethane foams.

The substrate can include one or more substances attached to a surface thereof. For example, a coverstock can be added to one or more surfaces of the substrate as a decorative surface material. The coverstock can include a fabric-to-foam laminate that is attached directly to one or more surfaces of the substrate to form the topcoat on the substrate. In some embodiments, the coverstock can be a textile, e.g., a knitted fabric, laminated to polyurethane foam. It will be appreciated that the coverstock can be oriented such that the foam layer of the coverstock is disposed between the substrate and the fabric, though in some embodiments, the fabric can abut the substrate. In some embodiments, the coverstock can have a multi-layered structure, which can form a reinforced headliner having a plurality of layers that can assist with acoustics, cushioning, and the like.

The coverstock can attach to the substrate in the absence of a heterogeneous adhesive. For example, the foam of the coverstock can attach the fabric to the substrate without using an intervening layer of adhesive. As compared to the dry process outlined above, the instantly disclosed process, in some embodiments, can replace the thermoplastic adhesive film layer with a thin amorphous and highly porous layer of cross-linked polyurethane, or foam, at the interface between the coverstock and the substrate to adhere the coverstock to the thermoformable board. More specifically, rather than utilize a thermoplastic adhesive film layer, a thin amorphous and highly porous layer of cross-linked polyurethane which adheres the cover-stock to the thermoformable board can be used. The porosity of the polyurethane can improve acoustic properties of the resulting headliner, with greater levels of porosity at the board interface leading to better acoustic properties. Such configurations allow adhesive properties of the cross-linked polyurethane to serve as the intermediary between the substrate and the fabric to attach the coverstock thereto, as discussed in greater detail below.

A person skilled in the art will recognize that the coverstock can include a plurality of foam backing layers. In some embodiments, the foam(s) can be used as a backing material that is laminated to the textile. The backing material can be used to maintain structural integrity, adhesion to a core of the headliner, and/or production efficiency. Backing materials for use with some embodiments can include any material that can be suitably laminated to an appropriate coverstock, though some embodiments utilize backing materials that are suitable to be used with textiles for interior surfacing of vehicles.

The amorphous polyurethane layer can be formed on the surface of, and can be comprised of, the polyurethane foam layer of the coverstock, such that the transition from the polyurethane foam layer of the coverstock to the amorphous layer is gradual and indiscernible. Such characteristics can allow the amorphous layer to be integral with the substrate to result in a failure proof interface. The amorphous polyurethane layer can be formed by the liquefaction and subsequent solidification and cross linking of a low-density polyurethane foam such as occurs when a polyurethane foam is adhered to another substrate using flame lamination. As a bonding agent, the amorphous polyurethane can be highly compatible with most thermoformable headliner substrates and can be cross linked. This creates a stronger, more durable bond, which can exhibit greater resistance to heat and chemicals than exhibited by thermoplastic film adhesives. The exceptional bonding characteristics of the amorphous urethane layer are such that this layer can substitute for both the thermoplastic adhesive film and the non-woven backing, in the case of headliner applications in which a non-woven backing is used to achieve the bond and durability specifications. Use of the amorphous urethane layer can result in greater durability in bonds in terms of initial strength and strength after environmental cycling. Further, by eliminating the adhesive layer, the instantly disclosed construction can achieve greater finished thickness and lower densities than the traditional process for a given initial thickness and weight. In some embodiments, use of the above-described construction can result in lower VOC emissions in the vehicle.

As discussed above, the foam of the coverstock can serve as an intermediary layer between the fabric and another material, e.g., the substrate, to adhere the fabric thereto. In other words, foam can be used to bond the fabric of the coverstock or another material to the substrate. This bonding can occur via polymerization and depolymerization of the foam in the coverstock. While it will be appreciated that, in some embodiments, the coverstock can bond to the substrate using a heterogenous liquid or film adhesive layer, bonding can be achieved without the heterogeneous adhesive layer, as discussed above. For example, in some embodiments, one or more foam layers can adhere to the fabric, thereby forming the coverstock, while also adhering to the substrate using the adhesive effects of the urethane and/or polyolefin (e.g., polyethylene and polypropylene) in the foam, thereby eliminating the need for the heterogeneous adhesive layer. The foam of the coverstock can be heated, flame-bonded, or otherwise agitated in a manner known to one skilled in the art to decompose the foam to allow the foam to serve as the intermediary between the substrate and another substance in the absence of the adhesive. In some embodiments, the process by which the foam adheres to the substrate is not a thermoplastic process.

The new headliner can provide more degrees of freedom for selecting coverstock materials. In some embodiments, materials with lower temperature resistance, or materials that are less tolerant of heat and/or pressure, can be employed, such as foams with densities below 1.7 pounds per ft³ or foams with lower levels of cross linking or which utilize fillers or recycled content. In some embodiments, foams with highly open cell structures or low air resistance can be used without the risk of adhesive bleed through, penetration, or surface irregularities. In some embodiments, lighter-weight headliner-coverstock materials can be used in lieu of, or in addition to, the standard knitted fabric. These lighter-weight materials can combine the desirable design attributes of flat-knit fabrics with the cost effectiveness of lighter fabric construction weights, e.g., less than about 2.55 oz per yd². For example, lightweight knit fabric (e.g., flat), which can have a weight less than about 2.55, 2.5, 2.45, 2.4, 2.35, 2.3, 2.25, 2.2, 2.15, or 2.1 oz/yd², can produce sleeker designs while saving the cost of heavier fabric for manufacturing.

In some embodiments, a knit fabric can be manufactured from flat and/or textured yarns, with the knit product being unbrushed, though the knit product can be brushed in some embodiments. Yarn generally includes a plurality of filaments that are interlocked. The filaments are interlocked by spinning, twisting, or otherwise bonding to form the yarn. The filaments can be the same or have different compositions. In some embodiments, the yarns can be synthetic in nature, e.g., including some type of synthetic material in one or more of the filaments. Examples include polymer-based yarns including those utilized by one skilled in the art during textile manufacturing. Specific types of polymer-based yarns include polyester, nylon, polypropylene and blends of the foregoing. The thickness of the yarn can vary depending upon the flat knit desired to be manufactured. For some embodiments herein, the thickness of the filament yarn can be greater than about 20 denier, about 30 denier, or about 40 denier. In other embodiments the thickness of the filament yarn can be smaller than about 100 denier, about 90 denier, about 80 denier, or about 70 denier. Accordingly, ranges of thickness can utilize any combination of the aforementioned upper and lower limits (e.g., between about 20 denier and about 100 denier, or between about 40 denier and about 70 denier). Yarns can be formed into a variety of types of patterns to form the knit fabric. For instance, fabrics can be in a warp knit (e.g., tricot) or circular knit (e.g., interlock).

It will be appreciated that use of a lightweight, e.g., less than about 2.55, 2.5, 2.45, 2.4, 2.35, 2.3, 2.25, 2.2, 2.15, or 2.1 ounces per square yard, flat, unbrushed knit fabric, in some embodiments, can aid in the creation of novel fabric laminates for a variety of uses such as in the interior spaces of vehicles. Other embodiments can be directed to the use of knit fabrics that are lightweight and brushed. Accordingly, such embodiments can include flat, brushed knit fabrics that have a weight less than about 2.3, 2.2, or 2.1 ounces per square yard. In some embodiments, these fabrics can optionally be unbrushed and/or flat.

Knit fabrics, consistent with some embodiments herein, can be produced using 2-bar or 3-bar 28 gage or 32 gage warp-knit tricot machines of the sort produced by the Karl Meyer machine company in Germany. In some embodiments, 3-bar knitting can be used to produce light weight flat knits since 3-bar knitting enables the creation of patterns in which the yarn is concentrated into dense areas and more open areas to create depth and complexity in the appearance even at low weights. For example, one exemplary manufactured knit fabric is a flat, unbrushed warp knit tricot, which is a 3 Bar, 28 g knit with a count of 35 wales/inch and 48 courses/inch, using 40 denier polyester having a weight of about 2.0 oz/yd². Lightweight flat knits can also be produced via a circular knitting process or other suitable process. Knit fabrics can be typically piece dyed to match a desired color. Jet dyeing can be preferable in some instances because it adds additional texture and bulk to the fibers, and can avoid the potential for moiré interference patterns that can be created by pressure beam dying.

It will be appreciated that both “closed” and “open” stitch patterns can be used. For example, a “closed” stitch pattern is defined here as a tightly stitched fabric with no gaps to create a continuous, uniform surface, while in some embodiments, a fabric (e.g., a knit fabric) can be open (i.e., the yarns are spaced apart sufficiently to allow one to see through the pore spaces, for example, sufficiently to see a backing material). Such open stitch fabrics can be laminated to a backing material or foam having a contrasting color or appearance relative to the knit fabric. For example, a foam can be laminated to the open knit to create a contrasting background appearance relative to the knit appearance, which can create additional visual characteristics.

Foams that can be laminated to the fabric to make up the coverstock, consistent with embodiments of the present invention, can utilize various materials and compositions. For example, in some embodiments, a fabric coverstock can be laminated to a polyester, polyether, or other polymer-based polyurethane foams. Some additional non-limiting examples of the materials that make up the foam can include polyurethanes, such as polyether urethane or polyester urethane, and/or polypropelene blend. In other embodiments, cross linked or thermoplastic polyethylene foam may be used. In some embodiments, the foam can have a density suitable for its specific application, e.g., in a range between about 1.4-4.0 lbs per ft³, or in a range between about 1.7 to about 2.2 lbs per ft³. For example, RA190050 foam with a density of 1.9 lbs per ft³ and a thickness of about 0.120 inches from Foamex (Linwood, Pa.) is suitable. Alternatively, the foam can be a 2.2 lb density foam, style number 2249RYRS @ 0.120″ available from Olympic Products (Greensboro, N.C.). In some embodiments, a high-density foam (e.g., density greater than about 2.5 lbs per ft³) is utilized to provide certain desired physical properties to the laminate, such as feel and resistance to foam crush in subsequent molding operations.

The coverstock can be comprised of just a decorative textile or textile-foam laminate, devoid of additional layers and/or substances, e.g., backing materials. While in some embodiments, the coverstock can include additional layers as the backing material, such as films (e.g., polymer-containing films), and non-woven materials such as spunlace materials, needle punched non-woven materials, and spunbonded non-woven materials, the coverstock can be manufactured without the backing material. It will be appreciated that the backing material or non-woven layer can be used in embodiments in which the adhesive is used to form the coverstock to serve as a processing aid that is incorporated on a side of a backing material opposite the flat knit fabric or interspaced between the backing material and the flat knit fabric to promote adhesion and/or to prevent adhesive bleeding into the or through the coverstock. By using foam to bond the substrate to the fabric, there is no risk of adhesive bleeding into or through the coverstock due to absence of the adhesive, and the backing material can be removed during manufacture, thereby reducing cost of manufacture. Removing the non-woven layer can also reduce the weight of the resultant headliner, which can reduce shipping and installation costs. A person skilled in the art will recognize that the absence of this layer can result in lower lifecycle carbon dioxide (CO₂) emissions given the elimination of any CO₂ used in manufacture of eliminated plies. It will be appreciated, however, that in some embodiments, the coverstock can include the backing material despite lacking adhesive, or the adhesive despite lacking the backing material.

A person skilled in the art will appreciate that in embodiments in which the non-woven layer is used, some examples can include a non-woven scrim (e.g., SR5120 available from Freudenberg, Germany), knit scrim (e.g., ND15D available from Guilford Mills, Wilmington, N.C.), film (e.g., 1.2 mil Vacuflex available from Omniflex, Greenfield, Mass.) or other suitable material. In other embodiments, polymeric films such as 1.2 mil Vacuflex polyether polyurethane available from Omniflex, Greenfield, Mass. or Polyolefin films, such as Dow 909, available from Dow Chemical, can be laminated to create a three-layer structure of coverstock/foam/film to create a three-layer laminate for certain applications requiring a barrier layer of film to prevent damage to the foam through subsequent processing.

It will be appreciated that in some embodiments, the coverstock can include additional materials in lieu of, or in addition to, the fabric discussed above. For example, after the foam bonds to the substrate, materials other than fabrics can be attached to the foam to make up the coverstock. The new headliner can provide more degrees of freedom for selecting coverstock materials. Some non-limiting examples of such materials can include tyvec, vinyl, decorative urethane films, colored film, lightweight non-woven, sueded materials, and so forth.

Manufacture of the Headliner

An exemplary method of using the materials disclosed herein for manufacturing the headliner discussed in the above embodiments is discussed below. Except as indicated below and will be readily appreciated by one having ordinary skill in the art, the steps of the described method can be performed in various sequences, and one or more steps can be omitted or added. A detailed description of every sequence of steps is omitted here for the sake of brevity.

The method consists of two steps. In the first step, a cover stock is laminated to a thermoformable substrate. In the second step, the laminated substrate is heated to the softening temperature and fed into a cold, two-sided forming tool and the two halves of the tool are brought together under pressure to form the headliner into the desired shape.

The coverstock can be attached to the substrate using a variety of mechanisms and equipment. For example, the foam layer of the coverstock can be passed under an energy source to liquify or decompose a small layer of the foam for bonding, e.g., via flame bonding. Flame bonding is a process used to produce laminates by bonding foam to fabric or foam to film by passing the surface of the foam under an open flame to adhere the foam to an additional substrate to attach the foam to the substrate. In flame bonding, foam is run past a flame to create a thin layer of liquified or decomposed polymer. The surface of foam that has been decomposed is then pressed together with a layer of fabric, film or vinyl. Exposure to the flame creates a thin layer of liquified polymer on the foam surface, which is then brought into contact with the secondary layer under pressure to develop a bond between the two surfaces. A bond is created when the chemical components of the decomposed polymer material between the layers react with one another and the polymer reconstitutes itself. Use of decomposed or liquified foam to bond the fabric to the substrate can eliminate the need for one and/or both the non-woven layer on the coverstock and the adhesive film layer on the formable substrate.

It will be appreciated that flame lamination can be used to laminate the coverstock to the substrate as a preliminary step to molding. Exposing the foam to a flame or other intense energy source can decompose the urethane and/or materials therein to activate adhesive properties of the foam to allow the foam to bond to surfaces. The foam can be heated to a temperature of at least 350 degrees Celsius to create a decomposed foam that activates the adhesive properties thereof, thereby allowing the foam to bond to the one or more surfaces of the substrate. It will be appreciated that the successful flame lamination of polyether urethane foam to the substrate does not occur by physically melting the urethane foam and then allowing it to cool and re-harden. Special reactive polyols in the foam that are capable of decomposing when heated above approximately 350 degrees Celsius allow the foam to form a pyrolytic decomposition product that is a low molecular weight urethane that contains free isocyanate groups with good adhesive properties. As the foam surface cools, the free isocyanate groups react with the —OH groups in the polymer and disappear and the final cured bond strength can be developed over the next 12-24 hours. The decomposition of polyether urethane without these additives produces a surface that is powdery when cooled and has no adhesive properties.

The foam can be decomposed using a gas fired ribbon burner to achieve the desired temperature. In some embodiments, other forms of energy can be applied to the foam to cause a selected portion thereof to decompose. Once the adhesive properties of the foam are activated, the tension on the foam and the fabric can be adjusted, e.g., via compression of the two substances, to form the coverstock.

It will be appreciated that flame lamination of a polyester urethane foam, in some embodiments, can be much faster than polyether foam because the pyrolysis products created by the decomposition of the foam surface are much higher molecular weight and are also more viscous and tacky. These newly formed reaction products can also return to solid form faster than with flame bondable polyether foam formulations, so the green bond strength is developed faster as well. In some embodiments, there can be some thermoplastic character inherent in the reaction product of toluene diisocyanate (TDI) and diethylene glycol. Diethylene glycol units are present in polyester polyols but not in polyether polyols. Therefore, polyester foam does have a small amount of the characteristics of a hot melt adhesive, but various properties can allow for the bond to form to the substrate.

It will be appreciated that one skilled in the art will recognize that headliners prepared via flame bonding can be easily identified as compared to headliners that use adhesive to bond the coverstock to the substrate. For example, flame bonded headliners are lighter than conventional headliners due to the absence of one or more of the adhesive layer and the non-woven layer. Further, headliners that lack the adhesive layer exhibit improved acoustic properties as compared to conventional headliners as the direct contact between the substrate and the coverstock allows for sound to reverberate through the vehicle. Also, flame bonded headliners of this type exhibit no film layer or foreign adhesive substance on the surface of the substrate that is closest to the coverstock.

In some embodiments, the foam can be heated such that attaching the coverstock to the substrate can be performed simultaneously with attaching the fabric to the foam. For example, after heating the foam to a temperature sufficient to activate the adhesive properties of the foam, the fabric can be laminated to the foam to form the coverstock, while the substrate is attached opposite the fabric to form the all-in-one formable component. Simultaneous flame lamination of the coverstock and attachment of the coverstock to the substrate can reduce the time and expense associated with manufacture of the headliner, thereby allowing production of greater quantities of the headliner. By pre-laminating the coverstock to the substrate to form an all-in-one board that can be used in headliner production, the potential for lamination defects, which may develop in the forming process, such as wrinkling or creasing, mottling (caused by adhesive bleed through), and lamination strength failures, is reduced. Further, molding cycle time can be reduced by eliminating any need to achieve lamination in the mold, thereby increasing the rate of production of the headliner. Further, pressures in the molding tool may be reduced allowing for greater expansion of the substrate achieving lower densities in the finished board.

In some embodiments, the foam, substrate, and fabric can be introduced into a machine to attach the foam to the substrate while flame laminating the fabric to the foam to form the coverstock in a single process step. In such cases, the fabric and foam may be laminated together via flame lamination in a first process stage, and then passed under a second lamination station on the same machine where the fabric foam laminate will be attached to the substrate.

In some embodiments, the substrate layer can be cut into sheets prior to lamination and the lamination machine can be configured to perform sequential, roll-to-roll and/or roll-to-sheet lamination to expedite the manufacture of the headliner. In such embodiments, the machine may incorporate a horizontal conveyor system to convey the substrate under the flame burner. The conveyor system will need to survive direct exposure to flame and may consist of a metal fabric or mesh material.

In some embodiments, the substrate can be run from continuous rolls. In such cases, the machine may include provisions for cutting the finished laminated into sheets of the desired length. It will be appreciated that flame bonding can be performed on polyurethanes, fabrics, and other articles that are rolled and unrolled. In some embodiments, the flame lamination can be performed to manufacture discontinuous sheets. The machine can be configured to use the decomposed foam as the bonding agent which attaches to one or more of the fabric and the substrate. It will be appreciated that the machine can be configured to utilize a unique combination of advanced process control technologies that can manage quality and material cost of the resultant headliner. For example, various software and hardware can be added to the machine that can match sheets to defect-free sections of the fabric roll to isolate defects commonly seen in fabrics to minimize the amount of substrate scrap.

In some embodiments, the flame bonding can be continuous and/or performed at high speeds to laminate continuous rolls of fabric and foam to individual semi-rigid thermoformable substrate boards. For example, the manufacturing can be performed using a continuous process to manufacture the coverstock at a selected rate (e.g., about 25 to about 50 yards/minute) for attaching to the substrate. Commercial flame laminators (e.g., equipment from McGuckin and Pyle, Downingtown, Pa.) can be utilized, configured appropriately to provide and handle the coverstock and components thereof as described in the present application. The headliner manufacturing process can also result in simplified logistics and accounting.

Compression of the fabric to the foam to form the coverstock laminate can be performed in any manner appropriate to achieve laminates consistent with some embodiments described herein. In some instances, compression can be performed by inserting the components of the coverstock between multiple rollers. For example, the rollers can be in a vertically stacked, two-roll design. The gap between the rollers can be adjusted, for example, to be set relatively open. In some embodiments, the coverstock can be compressed less than about 50% relative the uncompressed coverstock, backing material, or the combination of the two.

In some embodiments, the flame laminator discussed above can include specially configured feeding systems to delay the feed of a substrate sheet to avoid laminating the sheet to defective areas of coverstock. The laminator may also use technology to avoid processing issues created by large gaps in the substrate feed, such as the capability to feed a release sheet through the process underneath the substrate, which will keep the liquified foam from sticking to or contaminating machine surfaces. In some embodiments, the burner can be programmed to shut off or turn away from the foam to avoid liquifying the exposed surface of the foam when no substrate sheet is present. The flame laminator can incorporate computer vision systems, either in line or up-stream, to identify coverstock defects and coordinate sheet feed delays with defects so as to avoid lamination to same.

The molding process for the exemplary method consists of a heating the substrate laminate to the softening point and then quickly pressing it between the two matching sides of a cold molding tool. The tool halves may be pressed together in a molding press using pneumatic or hydraulic cylinders. The tool may be shimmed so they close to a calibrated distance, or allowed to fully close, limited only by the countervailing pressure created when the tools come in contact with and compress the substrate.

It shall be noted that in the exemplary method, the molding step requires just a single raw material component consisting of a cover stock-substrate laminate. This contrasts with existing methods in which 2 or more plies are fed separately into the press. Using a single raw material component simplifies the process and eliminates the need for a separate handling system for each ply. It thus reduces multi-stage handling systems that add to the size and cost of the molding process lines.

It shall also be noted that pre-applying the cover-stock to the substrate eliminates the need for effecting lamination in a forming tool, so the need for activating an adhesive film to affect lamination is eliminated. This reduces the amount of heat energy and pressure required for the molding step and also the need to heat the substrate fully on both of its faces. Someone skilled in the art will understand that reducing the pressure in the molding step will allow for greater expansion of the formable substrate and thus achieve a lower density and greater finished thickness of the substrate layer of the finished headliner. It shall also be noted that eliminating the need for lamination in the tool may shorten the required dwell time in the molding step and thereby increase the output rate and productivity of the process.

Moreover, using flame lamination rather than the adhesive layer can eliminate defects that can be caused by the in-tool lamination process and/or reduce bond failures between the substrate and the coverstock. It will be appreciated that in some embodiments, omission of an adhesive film layer can allow the coverstock to attach to the substrate at lower temperatures.

In molding, which follows the process of flame lamination, can be configured to utilize a reduced capital footprint for material handling given the consolidation of the bill of materials to a single component. For example, due to the absence the adhesive film, there is no activation of adhesive properties thereof, thereby reducing overall heating cycle time to the time taken for the adhesive properties of the foam to activate. The absence of various layers from the flame lamination and molding steps, e.g., adhesive film layer, non-woven fabric, and so forth, reduces the material cost of the manufacturing process. The absence of the adhesive film can limit and/or eliminate the capital and space cost associated with storing these materials, as well as limit and/or eliminate amounts of coverstock lamination related scrap typically generated during the molding process.

APPENDIX A, which is incorporated herein physically and by reference, provides details and summaries of various described, additional, and/or alternative exemplary embodiments.

APPENDIX B, which is incorporated herein physically and by reference, provides details and summaries of various described, additional, and/or alternative exemplary embodiments.

As discussed herein, exemplary embodiments include a pre-laminated thermoformable board having a cover (e.g., a textile) flame-bonded to a substrate (e.g., glass-filled expanded polypropylene substrate) via a cooled polyurethane foam melt without an intervening layer of adhesive.

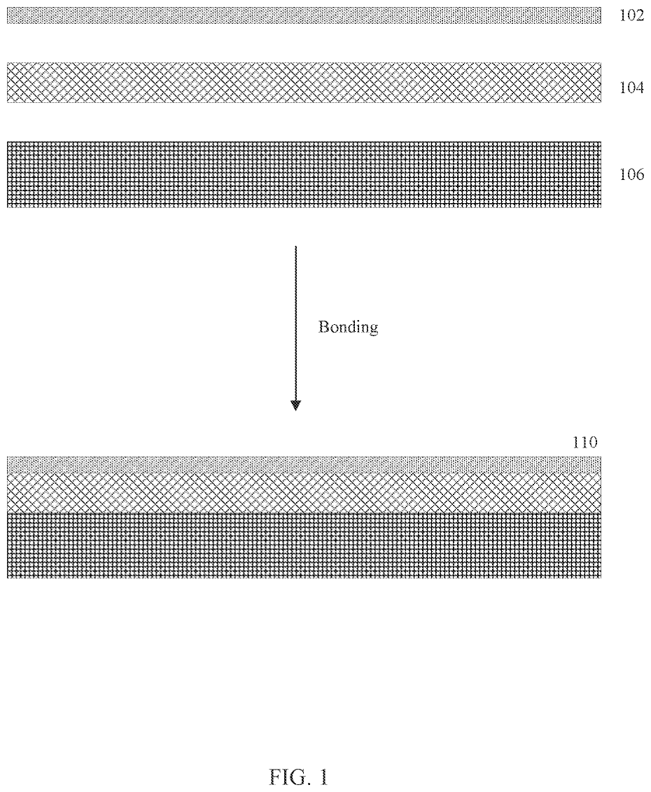

FIG. 1 is a schematic diagram showing formation of a discontinuous thermoformable or thermoformed composite product in accordance with a first exemplary embodiment. Here, a cover 102, a polyurethane foam 104, and a substrate 106 are provided separately and placed in a bonding machine with the polyurethane foam 104 interposed between the cover 102 and the substrate 106 substantially as shown. Energy is then applied to activate adhesive properties of the polyurethane foam 104 to create a first amorphous and porous urethane layer that directly bonds the polyurethane foam 104 to the substrate 106 without an intervening layer of adhesive and simultaneously creates a second amorphous and porous urethane layer that directly bonds the polyurethane foam 104 to the cover 102 to produce the composite product 110. The energy may be applied by flame bonding or other appropriate process. The polyurethane foam 104 may be heated to a temperature of at least 350 degrees Celsius to decompose reactive polyols contained therein. The first and second amorphous and porous urethane layers may be pyrolytic decomposition layers of the polyurethane foam 104. Generally speaking, the direct bonding does not occur thermoplastically.

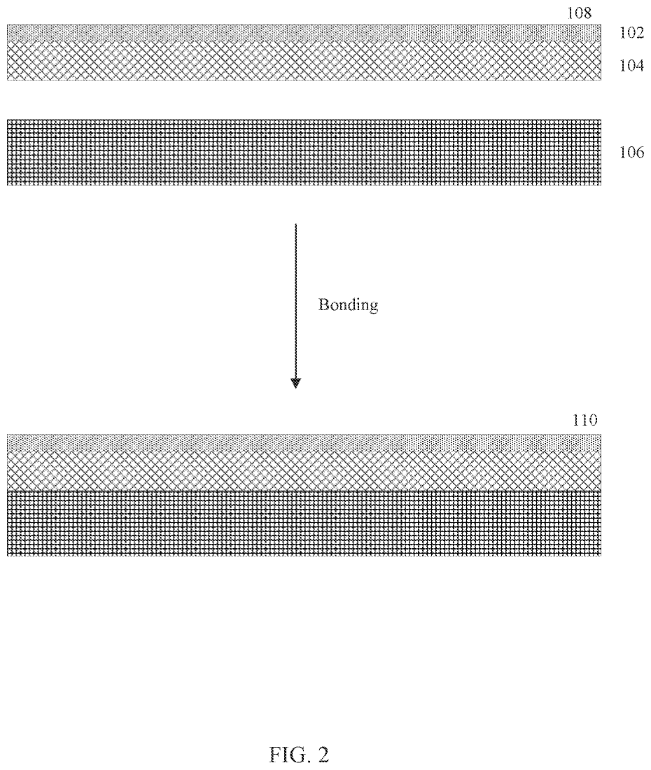

FIG. 2 is a schematic diagram showing formation of a discontinuous thermoformable or thermoformed composite product in accordance with a second exemplary embodiment. Here, a cover-to-foam laminated coverstock 108 (including a cover 102 and a polyurethane foam 104) and a substrate 106 are provided and placed in a bonding machine with the polyurethane foam 104 interposed between the cover 102 and the substrate 106 substantially as shown. Energy is then applied to activate adhesive properties of the foam to create a first amorphous and porous urethane layer that directly bonds the polyurethane foam of the coverstock 108 to the substrate 106 without an intervening layer of adhesive to produce the composite product 110. The energy may be applied by flame bonding or other appropriate process. The polyurethane foam 104 may be heated to a temperature of at least 350 degrees Celsius to decompose reactive polyols contained therein. The first amorphous and porous urethane layer may be a pyrolytic decomposition layer of the polyurethane foam 104. Generally speaking, the direct bonding does not occur thermoplastically. The polyurethane foam 104 and the cover 102 of the cover-to-foam laminated coverstock 108 may be directly bonded by a second amorphous and porous urethane layer formed in a similar manner to the first amorphous and porous urethane layer, e.g., in a first step of a two-step laminating process in which the coverstock 108 is formed in a first laminating process and the composite product is formed in a second laminating process.

It should be noted that the bonding machines or processes described above with reference to FIGS. 1 and 2 can be configured for continuous or ongoing operation such as by feeding cover material and/or polyurethane foam and/or cover-to-foam laminated coverstock and/or substrate into the machine on an ongoing basis such that composite products can be produced therefrom on an ongoing basis.

Such a pre-laminated thermoformable board can be created by various processes discussed herein including, for example, flame bonding of a coverstock having a polyurethane backing onto the substrate. The pre-laminated thermoformable board then can be placed in a thermoforming molding machine, which in turn can be operated to produce a molded composite product such as a vehicle headliner or other product. One advantage of such a pre-laminated thermoformable board is that the decorative cover material has been precisely positioned on the substrate prior to bonding. Among other things, this can allow features that are pre-formed on the cover material (e.g., woven or printed details, openings, embellishments, etc.) to be precisely positioned on the board and hence on the final molded composite product in a way that would not have been possible or practicable with prior art products. For but one example, imagine a molded composite headliner that has various openings (e.g., such as for lights, vents, etc.), with the cover having printed features that now can be precisely positioned relative to such openings, e.g., to provide decorative borders or highlights.

The precise positioning of the design elements can be accomplished in a number of ways. In one embodiment, the design elements are formed on the cover material prior to adherence to the substrate. In a subsequent step, locating holes are created in precise locations relative to the design elements, and these holes are in turn used to affix the substrate in the desired position relative to the molding tool, using locating pins positioned for that purpose.

In a second embodiment, the cover layer is laminated to a substrate prior the application of the design elements. Locating holes are then added to the substrate and then used to precisely position the design elements on the pre-cut substrate sheet, such elements being applied in a subsequent printing or welding process in which incorporates locating pins for the precise location of the substrate.

It should be noted that the bonding machines or processes described above with reference to FIGS. 1 and 2 are not limited to production of composite boards but instead can be used to form other types of products, e.g., preformed composite products such as by providing a preformed substrate and then bonding to the cover onto the substrate as discussed herein.

Various embodiments of the present invention may be characterized by the potential claims listed in the paragraphs following this paragraph (and before the actual claims provided at the end of the application). These potential claims form a part of the written description of the application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public. Nor are these potential claims intended to limit various pursued claims.

Without limitation, potential subject matter that may be claimed (prefaced with the letter “P” so as to avoid confusion with the actual claims presented below) includes:

P1. A method for manufacturing a composite product, said method comprising providing a substrate; decomposing a polyurethane foam to form a pyrolytic decomposition product; attaching the substrate to the pyrolytic decomposition product; and pressing the pyrolytic decomposition product to an object to bond the object to the substrate.

P2. The method of claim P1, wherein the decomposed foam is attached to the substrate and the object simultaneously.

P3. The method of claim P1, wherein the substrate is a rigid and discontinuous glass-filled expanded polypropylene substrate.

P4. The method of claim P1, wherein decomposing the foam further comprises heating the foam to decompose one or more reactive polyols contained therein.

P5. The method of claim P4, wherein the foam is heated to above approximately 350 degrees Celsius.

P6. The method of claim P1, wherein bonding the object to the substrate and the foam is performed in the absence of an adhesive.

The described composition and methods are in no way limiting. A person skilled in the art, in view of the present disclosure, will understand how to apply the teachings of one embodiment to other embodiments either explicitly or implicitly provided for in the present disclosure. Further, a person skilled in the art will appreciate further features and advantages of the present disclosure based on the above-described embodiments. Accordingly, the disclosure is not to be limited by what has been particularly described, except as indicated by the appended claims. All publications and references cited herein are expressly incorporated herein by reference in their entirety.

### APPENDIX A

Headliners are formed from semi-rigid boards with a decorative layer on one side that comprise the interior ceiling of an automobile's (and other transport) passenger compartment. They perform a range of functions including 1.) anchoring interior components such as lights, vents, sun visors, wire harnesses; 2.) imparting desirable acoustic properties to the cockpit; 3.) anchoring and hiding functional infrastructure such as wire harnesses, air vents and airbags.

Headliners are manufactured using 1 of three general methods, all of which combine a decorative coverstock (typically comprised of a textile to foam laminate) with a semi-rigid formed/contoured base.

1. A wet process, in which liquid adhesives are used to adhere several layers, including the coverstock together using a hot forming tool.

2. A pre-form or two step process, in which a liquid urethane is used to create a molded base onto which a coverstock is adhered in a second step.

3. A dry process, in which a preheated thermoformable semi-rigid board is fed into a forming press together with the coverstock and the two layers are simultaneously molded and laminated together using a thermoplastic adhesive film.

This invention relates to improvements to the composition of headliners manufactured using the dry process. Simultaneously, we have invented a novel process for producing said headliners. Both inventions arise from the application of

New Headliner Construction Invention
We change the interface between the coverstock and the thermoformable substrate by replacing the thermoplastic adhesive film layer, with a thin amorphous and highly porous layer of cross-linked polyurethane which adheres the cover-stock to the thermoformable board.
The amorphous polyurethane layer is formed by the liquefaction and subsequent solidification and cross linking of a low-density polyurethane foam such as occurs when a polyurethane foam is adhered to another substrate using flame lamination.
The amorphous polyurethane layer is formed on the surface of and thus comprised of the polyurethane foam layer of the coverstock, such that the transition from the polyurethane foam layer of the coverstock to the amorphous layer is gradual and indiscernible. This amorphous layer is thus integral to, resulting in a failure proof interface.
As a bonding agent, the amorphous polyurethane is highly compatible with most thermoformable headliner substrates and is cross linked. This creates a stronger more durable bond which is resistant to heat and chemicals than that which is exhibited by thermoplastic film adhesives.
The exceptional bonding characteristics of the amorphous urethane layer are such that this layer can substitute for both the thermoplastic adhesive film and the non-woven backing for headliner applications in which a non-woven backing is necessary to achieve the bond and durability specifications.

The benefits of our new headliner construction are numerous, as follows:
Greater levels of porosity at the board interface leads to better acoustic properties
Cost savings due to the elimination of the film and non-woven
Weight savings due to elimination of same
More degrees of freedom in selecting coverstock materials
Potential for achieving greater finished thickness and lower densities for a substrate with a given initial thickness and weight.
Greater durability in bonds in terms of initial strength and strength after environmental cycling.
Lower lifecycle CO2 emissions given the elimination of any CO2 used in manufacture of eliminated plies.
Lower VOC emissions in vehicle

Claims: (not exhaustive)
Formed Headliner which uses amorphous and porous urethane layer
Formed Headliner without film adhesive or non-woven for applications requiring same
Headliner pre-form sheet with pre-applied cover stock using amorphous urethane layer
Headliner pre-form sheet with pre-applied cover stock with amorphous urethane layer without film adhesive or non-woven for applications requiring same.

New Process for Producing a Headliner Using Thermo-Formable Substrates

We have invented a new process for the manufacture based on the novel application of flame lamination to pre-apply the coverstock and thereby eliminate the need for effecting lamination in the forming tool.
Use flame lamination to laminate the cover stock to the thermoformable substrate as a preliminary step prior to molding. Molding is performed in a second step.
Flame lamination to board may be combined with the lamination of the coverstock step in a single pass
Flame laminator specially configured to laminate continuous rolls of fabric and foam to individual semi-rigid thermoformable substrate boards.
Flame laminator includes specially configured feeding systems to delay the feed of a substrate sheet to avoid laminating the sheet to defective areas of coverstock along with technology to avoid processing issues created by large gaps in the substrate feed
Flame laminator incorporates computer vision systems, either in line or up stream to identify coverstock defects and coordinate sheet feed delays with defects do as to avoid lamination to same.
Flame laminator incorporates technology that separates or folds sheets after lamination as a replacement for traditional winding processes which are not appropriate to this application.
Flame laminator may also be configured to run the substrate in continuous roll for, with provisions for stacking and sheeting the finished product.
The molding process may be specially configured to utilize a reduced capital footprint for material handling given the consolidation of the bill of materials to single component
The heating cycle time may be reduced in the absence of the need to activate the adhesive properties of the thermoplastic adhesive film.
The molding cycle time may be reduced, thus increasing the rate of production, by eliminating the need to achieve lamination in the mold.
Pressures in the molding tool may be reduced allowing for greater expansion of the substrate achieving lower densities in the finished board.

The benefits of our new headliner manufacturing process are numerous, as follows:
Reduced material cost, non-woven, film, and substrate
Reduced capital and space cost
Faster cycle times
Simplified logistics and accounting
Elimination of defects caused by in tool lamination process
Reduction in bond failures
Elimination of cover stock lamination related scrap in the molding process

### APPENDIX B

Our Invention:

1.) An innovative design for a lower cost, improved performance molded automotive headliner, and an all in one moldable board for use in the production of an automotive headliner.

2.) An all in one thermoformable board with a foam fabric top coat, used for the low-cost, low-investment production of the aforementioned automotive headliner.

Current State of the Art:

Automotive headliners are typically made using one of two manufacturing processes.

In the so-called “wet process”, a thermoformable semi-rigid MDI-based urethane foam is combined with glass fiber, nonwoven “scrim”, and coated with a catalyzed reactive liquid urethane adhesive. The structure is then fed into a heated tool, along with a textile laminate consisting of a warp-knit tricot flame laminated to polyurethane foam and a non-woven barrier layer (“Cover Stock”). The heat and pressure in the tool work to activate the adhesive, which bonds the materials together into a rigid contoured structure that is ready for installation in an automobile.

In what's often referred to as the “dry process”, a thermoformable substrate comprised of glass impregnated polypropylene topped with a heat-activatable adhesive film, is heated to the softening point, then combined with the “Cover Stock” and simultaneously laminated and formed in a cold mold. The polypropylene substrate may also incorporate a heat activated blowing agent to expand the polypropylene board to provide additional thickness, a more open cell structure with associated acoustical benefits.

An alternative implementation of the dry process replaces the polypropylene sheet with a prelaminated structure of an MDI urethane core foam, chopped glass, non-woven scrim similar to the “wet process”, but using heat activatable film to pre-laminate the materials into a substrate which is then molded and laminated to the “Cover Stock”, much like the glass filled polypropylene sheet above.

Limits of the Current Approach:

While the current approach is effective at producing commercially acceptable parts, it is has a number of drawbacks:
1. Headliners made with either of the current processes typically include a costly non-woven fabric layer on the back of the fabric pre-laminate. The nonwoven layer is simply a processing aid that adds both weight and cost without performing a function in the finished product. In the dry process, the non-woven layer is employed to present a better bonding surface to the adhesive film and thereby improve adhesion. In the wet process, the non-woven is there to prevent adhesive bleeding through into the fabric/foam laminate.
2. The in-tool lamination process for both processes, is slow and difficult to control and is subject to variation such as surface irregularities (“mottling”) and lamination strength failures.
3. The preparation, heating and feeding of multiple layers into the molding press in a controlled fashion requires a large, automated handling systems resulting in high levels of capital investment and takes up a great deal of space, raising fixed costs and the minimum efficient scale (breakeven volume) of the typical headliner molding plant.

Description of Our Invention

A process for producing a headliner using an all in one thermoformable composite with a fabric-to-foam laminate (“Cover-Stock”) already attached to the surface. Attaching the Cover Stock to the thermoformable board is accomplished simultaneous with the flame lamination of the fabric to the foam Cover Stock in a specially designed flame lamination machine. The machine, designed specifically for this purpose, performs simultaneous, roll-to-roll and roll-to-sheet lamination, using only liquified foam as the bonding agent and a unique combination of advanced process control technologies to manage quality and material cost.

Advantages of the New Process

Using liquified foam as the bonding agent, which eliminates the need for both the non-woven layer on the textile cover stock and the adhesive film layer on the formable substrate. This reduces both the cost and weight of the finished headliner. Removing the film layer also has the potential to improve the acoustic properties of the finished headliner.

In addition, the new headliner structure and production method also offers a number of process advantages. First, the prelaminated board eliminates the potential for a variety of lamination defects which may develop in the forming process, including wrinkling or creasing, mottling (caused by adhesive bleed through), and lamination strength failures. Second, because there is no need to achieve lamination during the molding cycle, the cycle time required to process the prelaminated substrate may be significantly shorter and require lower pressure. Third, the use of a single raw component greatly simplifies the process and greatly reduces the capital footprint and associated investment required for production, and likewise reduces material handling, inventory, and administration costs relative to the current approach.

We make the following preliminary claims for our invention:
1. A formed automotive headliner board consisting of glass-filled, expanded polypropylene-substrate, such as produced by Hanwha Azdel, with a textile to polyurethane foam laminated Cover Stock, where the Cover Stock has been attached directly to the surface of the substrate without an intervening layer of adhesive.
2. A formed headliner board as above, in which the substrate is comprised of glass encased, expanded polyurethane.
3. The process for making either of the above formed-headliners using a single raw component, comprised of a one piece formable substrate prelaminated to a “Cover Stock, where the “Cover Stock” has been attached directly to the surface of the substrate without an intervening layer of adhesive.
4. A one-piece formable substrate, made from a glass-encased polyurethane base, which has been prelaminated to a “Cover Stock”, where the “Cover Stock” has been attached directly to the surface of the substrate without an intervening layer of adhesive.
5. A one-piece formable substrate as above, but made from a glass-filled polypropylene base.

What is claimed is:

1. A discontinuous thermoformable composite product, comprising:
a polyurethane foam;
a rigid substrate; and
a cover;
wherein the cover is bonded to the polyurethane foam, and wherein the polyurethane foam is directly bonded to the substrate by a first amorphous and porous urethane product of the polyurethane foam without an intervening layer of adhesive.

2. The discontinuous thermoformable composite product of claim 1, wherein the first amorphous and porous urethane product is a pyrolytic decomposition product of the polyurethane foam.

3. The discontinuous thermoformable composite product of claim 1, wherein the foam is any one of a polyester, polyether, or other polymer-based polyurethane foam.

4. The discontinuous thermoformable composite product of claim 1, wherein the foam has a density in a range from about 1.4 pounds per cubic foot to about 4.0 pounds per cubic foot.

5. The discontinuous thermoformable composite product of claim 1, wherein the foam has a density in a range from about 1.7 pounds per cubic foot to about 2.2 pounds per cubic foot.

6. The discontinuous thermoformable composite product of claim 1, wherein the foam includes one or more reactive polyols that decompose when heated.

7. The discontinuous thermoformable composite product of claim 1, wherein the cover is directly bonded to the polyurethane foam by a second amorphous and porous urethane product of the polyurethane foam without an intervening layer of adhesive.

8. The discontinuous thermoformable composite product of claim 1, wherein the cover and the polyurethane foam are provided as a cover-to-foam laminated coverstock and wherein the polyurethane foam of the coverstock is directly bonded to the substrate by the first amorphous and porous urethane product of the polyurethane foam without an intervening layer of adhesive.

9. The discontinuous thermoformable composite product of claim 8, wherein the cover is directly bonded to the polyurethane foam by a second amorphous and porous urethane product of the polyurethane foam without an intervening layer of adhesive.

10. The discontinuous thermoformable composite product of claim 1, wherein the substrate comprises a plurality of materials that are pre-formed into a single piece.

11. The discontinuous thermoformable composite product of claim 1, wherein the substrate is a discontinuous glass-filled expanded polypropylene substrate.

12. The discontinuous thermoformable composite product of claim 1, wherein the materials of the substrate are thermoformable.

13. The discontinuous thermoformable composite product of claim 1, wherein the cover is a textile.

14. The discontinuous thermoformable composite product of claim 13, wherein the textile does not include a non-woven fabric layer.

15. The discontinuous thermoformable composite product of claim 13, wherein the textile includes a knitted fabric.

16. The discontinuous thermoformable composite product of claim 15, wherein the knit fabric weighs less than about 2.2 ounces per square yard.

17. The discontinuous thermoformable composite product of claim 15, wherein the knit fabric is a lightweight flat knit fabric.

18. The discontinuous thermoformable composite product of claim 1, wherein the discontinuous thermoformable composite product is a pre-laminated thermoformable board.

19. The discontinuous thermoformable composite product of claim 1, wherein the discontinuous thermoformable composite product is a component for a vehicle interior.

20. The discontinuous thermoformable composite product of claim 19, wherein the component is a vehicle headliner.

21. A method for manufacturing a discontinuous thermoformable composite product, said method comprising:
providing a rigid substrate;
providing a polyurethane foam;
providing a cover; and
forming a discontinuous thermoformable composite product in which the cover is bonded to the polyurethane foam and the polyurethane foam is directly bonded to the substrate by a first amorphous and porous urethane product of the polyurethane foam without an intervening layer of adhesive, said forming comprising applying energy to the polyurethane foam to create the first amorphous and porous urethane product.

22. The method of claim 21, wherein applying energy to the polyurethane foam comprises flame bonding.

23. The method of claim 21, wherein applying energy to the polyurethane foam comprises heating the polyurethane foam to a temperature of at least 350 degrees Celsius to decompose reactive polyols contained therein.

24. The method of claim 21, wherein the first amorphous and porous urethane product is a pyrolytic decomposition product of the polyurethane foam.

25. The method of claim 21, wherein directly bonding the polyurethane foam to the substrate does not occur thermoplastically.

26. The method of claim 21, wherein the foam is any one of a polyester, polyether, or other polymer-based polyurethane foam.

27. The method of claim 21, wherein the foam has a density in a range from about 1.4 pounds per cubic foot to about 4.0 pounds per cubic foot.

28. The method of claim 21, wherein the foam has a density in a range from about 1.7 pounds per cubic foot to about 2.2 pounds per cubic foot.

29. The method of claim 21, wherein the foam includes one or more reactive polyols that decompose when heated.

30. The method of claim 21, wherein providing the polyurethane foam and the cover comprises providing a cover-to-foam laminated coverstock.

31. The method of claim 30, wherein providing the cover-to-foam laminated coverstock comprises:
forming the cover-to-foam laminated coverstock by applying energy to the polyurethane foam to create a second amorphous and porous urethane product of the polyurethane foam that directly bonds the polyurethane foam to the cover without an intervening layer of adhesive.

32. The method of claim 21, wherein the rigid substrate, the polyurethane foam, and the cover are provided separately, and wherein applying energy to the foam creates the first amorphous and porous urethane product and creates a second amorphous and porous urethane product of the polyurethane foam to directly and simultaneously bond the polyurethane foam to both the cover and the substrate without intervening layers of adhesive.

33. The method of claim 21, wherein the substrate comprises a plurality of materials that are pre-formed into a single piece.

34. The method of claim 21, wherein the substrate is a discontinuous glass-filled expanded polypropylene substrate.

35. The method of claim 21, wherein the cover is a textile.

36. The method of claim 21, wherein the method is continuous.

37. The method of claim 21, wherein the discontinuous thermoformable composite product is a pre-laminated thermoformable board.

38. A method for manufacturing a molded composite product, said method comprising:
providing a pre-laminated thermoformable board having polyurethane foam bonded to a cover and directly bonded to a substrate by a first amorphous and porous urethane product of the polyurethane foam without an intervening layer of adhesive;
placing the pre-laminated thermoformable board in a thermoforming molding machine; and
operating the thermoforming molding machine to form the molded composite product.

39. The method of claim 38, wherein the molded composite product is a component for a vehicle interior.

40. The method of claim 39, wherein the component is a vehicle headliner.
